(19) United States
(12) Patent Application Publication
(10) Pub. No.: US 2026/0126282 A1
(43) Pub. Date: May 7, 2026

(54) PRISM MOTOR, METHOD FOR DETECTING A ROTATION ANGLE OF A PRISM MOTOR, AND PHOTOGRAPHING MODULE

(71) Applicant: Chipsemi Semiconductor (NingBo) Co., Ltd., Ningbo (CN)

(72) Inventors: Jun ZOU, Ningbo (CN); Yaoguo ZHANG, Ningbo (CN); Yulin ZHANG, Ningbo (CN)

(21) Appl. No.: 19/369,139

(22) Filed: Oct. 24, 2025

Related U.S. Application Data
(63) Continuation of application No. PCT/CN2025/101179, filed on Jun. 16, 2025.

(30) Foreign Application Priority Data
Nov. 5, 2024 (CN) 202411572917.9

(51) Int. Cl. G01B 7/30; G01D 5/241; H04N 23/55

(52) U.S. Cl. CPC G01B 7/30; G01D 5/241; H04N 23/55

(57) ABSTRACT

A prism motor, a method for detecting a rotation angle of a prism motor, and a photographing module are provided. In the prism motor, the first electrode plate is located on a surface of the prism base; the second electrode plate is located on a surface of the prism carrier and disposed opposite to the first electrode plate, and in a case where the prism carrier rotates in one direction about a first rotation axis, either an opposing area between the first electrode plate and the second electrode plate increases while a spacing between the first electrode plate and the second electrode plate decreases, or an opposing area between the first electrode plate and the second electrode plate decreases while a spacing between the first electrode plate and the second electrode plate increases; and the processing unit is configured to determine a rotation angle of the prism carrier.

### CROSS REFERENCE TO RELATED APPLICATIONS

This application is a continuation of PCT Patent Application No. PCT/CN2025/101179, entitled “PRISM MOTOR, METHOD FOR DETECTING A ROTATION ANGLE OF A PRISM MOTOR, AND PHOTOGRAPHING MODULE,” filed Jun. 16, 2025, which claims priority to Chinese Patent Application No. CN202411572917.9, entitled “PRISM MOTOR, METHOD FOR DETECTING A ROTATION ANGLE OF A PRISM MOTOR, AND PHOTOGRAPHING MODULE,” filed on Nov. 5, 2024, which is incorporated by reference herein in its entirety.

### TECHNICAL FIELD

The various embodiments described in this document relate in general to the field of camera technology, and more specifically to a prism motor, a method for detecting a rotation angle of a prism motor, and a photographing module.

### BACKGROUND

Currently, a periscope photographing module typically uses a prism to refract incident light. By folding the incident light, a focal length of the photographing module is extended, thereby enhancing a zoom capability of the photographing module. During image acquisition using the photographing module, a propagation angle of the incident light can be changed by rotating a prism carrier in the prism motor, thus altering an imaging effect of the photographing module. A rotation angle of the prism carrier is usually detected by a built-in Hall sensor or a driver chip with Hall detection function.

However, the prism rotation angle detection function in current periscope photography modules has at least the following drawbacks. The Hall sensor or driver chip with Hall detection function requires cooperation with a corresponding magnet to achieve angle measurement. Arranging the Hall sensor and corresponding magnet inside the prism motor occupies a large internal space of the motor, which is detrimental to miniaturization of the motor. On the other hand, given a fixed internal space of the motor, the Hall sensor and magnet occupying a large space also restrict a volume of the driving module for the prism motor, thereby being detrimental to improving driving capability of the prism motor.

### SUMMARY

Embodiments of the present disclosure provide a prism motor, a method for detecting a rotation angle of the prism motor, and a photographing module, which saves internal volume occupied within the prism motor for implementing detection of a rotation angle of the prism motor, facilitates miniaturization of the prism motor, and enhances effectiveness in detecting a deviation angle of the prism carrier.

To solve the above technical problem, embodiments of the present disclosure provide a prism motor, including: a prism base, a prism carrier, a first electrode plate, a second electrode plate, and a processing unit. The prism carrier is spaced apart from the prism base, where the prism carrier is rotatable relative to the prism base. The first electrode plate is located on a surface of the prism base. The second electrode plate is located on a surface of the prism carrier and disposed opposite to the first electrode plate, where the first electrode plate and the second electrode plate form a capacitor, and in a case where the prism carrier rotates in one direction about a first rotation axis, either an opposing area between the first electrode plate and the second electrode plate increases while a spacing between the first electrode plate and the second electrode plate decreases, or an opposing area between the first electrode plate and the second electrode plate decreases while a spacing between the first electrode plate and the second electrode plate increases. The processing unit is configured to determine a rotation angle of the prism carrier based on a capacitance signal generated by the capacitor formed by the first electrode plate and the second electrode plate.

The embodiments of the present disclosure further provide a method for detecting a rotation angle of a prism motor, applied to the above prism motor. The method includes: determining an initial capacitance signal generated by the capacitor formed by the first electrode plate and the second electrode plate at an initial position of the prism carrier; determining a current capacitance signal upon a change in capacitance signal generated by the capacitor formed by the first electrode plate and the second electrode plate; and determining a rotation angle of the prism carrier based on a difference between the current capacitance signal and the initial capacitance signal.

The embodiments of the present disclosure further provide a photographing module, including: the above prism motor, a lens, and a photosensitive chip, where incident light entering the photographing module is reflected by the prism motor, passes through the lens, and reaches the photosensitive chip.

Compared with the related art, in the embodiments of the present disclosure, the first electrode plate is disposed on the prism base, the second electrode plate is disposed on the prism carrier, the capacitor formed by the first electrode plate and the second electrode plate is utilized to determine a rotation angle of the prism carrier based on a change in capacitance signal, thereby enabling compensation for an angle change caused by shaking. Replacing a Hall sensor with electrode plates occupying smaller volume in the motor saves internal space occupied for implementing shake prevention technology in the prism motor, which is beneficial for miniaturization of the motor. Additionally, in the case where the prism carrier rotates in one direction, both an opposing area and a spacing between the first electrode plate and the second electrode plate change simultaneously, and changes in the opposing area and the spacing have the same effect on capacitance signals, namely, changes in the opposing area and the spacing both cause an increase in capacitance signal or both cause a decrease in capacitance signal. Therefore, simultaneous changes in the opposing area and the spacing render a larger variation amplitude of the capacitance signal under the same rotation angle condition, which makes detection of the angular rotation of the prism carrier more sensitive and improves effectiveness of detecting an offset angle of the prism carrier.

In some embodiments, a number of first electrode plates is even, and the first electrode plates are symmetrically arranged about a first plane where a first rotation axis of the prism carrier is located, the first plane being perpendicular to a plane where the first electrode plates are located; a number of second electrode plates is even, and the second electrode plates are symmetrically arranged about the first plane; the first electrode plates are in one-to-one correspondence with the second electrode plates, and each respective first electrode plate of the first electrode plates and a respective second electrode plate of the second electrode plates forms a capacitor; and the processing unit is configured to determine the rotation angle of the prism carrier based on a capacitance signal generated by the capacitor formed by the respective first electrode plate and the respective second electrode plate. By increasing the number of electrode plates to augment the number of capacitors used for detecting the rotation angle, and through comprehensive analysis of capacitance signals from multiple sets of capacitors, detection accuracy of the rotation angle can be further improved.

In some embodiments, each of the first electrode plates is symmetrically arranged about a second plane where a second rotation axis of the prism carrier is located, and each of the second electrode plates is symmetrically arranged about the second plane the second plane being perpendicular to the plane where the first electrode plates are located, where the first rotation axis and the second rotation axis are mutually perpendicular. In the case where the prism motor is rotatable in multiple directions, by configuring the electrode plates as symmetrically arranged structures, changes in capacitance signals of multiple sets of capacitors formed by the plurality of electrode plates remain substantially consistent during rotation, thereby facilitating minimizing interference from rotation angles in another direction on detection results through subsequent calculations, and thereby improving accuracy in calculating the rotation angle for rotation in a single direction.

In some embodiments, the first electrode plate has a length greater than a length of the second electrode plate, where a length direction of the first electrode plate is parallel to the first rotation axis. This configuration reduces interference of the rotation angle in another direction (e.g., the second rotation axis) on the change in magnitude of capacitance signals generated by the first electrode plate and the second electrode plate during rotation about the first rotation axis.

In some embodiments, the prism motor further includes a third electrode plate, located on the surface of the prism base; and a fourth electrode plate, located on the surface of the prism carrier and disposed opposite to the third electrode plate, where the third electrode plate and the fourth electrode plate form a capacitor, and in a case where the prism carrier rotates in one direction about a second rotation axis, either an opposing area between the third electrode plate and the fourth electrode plate increases while a spacing the third electrode plate and the fourth electrode plate decreases, or an opposing area the third electrode plate and the fourth electrode plate decreases while a spacing the third electrode plate and the fourth electrode plate increases, where the first rotation axis and the second rotation axis are mutually perpendicular. The processing unit is configured to collectively determine a spatial rotation angle of the prism carrier based on the capacitance signal generated by the capacitor formed by the first electrode plate and the second electrode plate and a capacitance signal generated by the capacitor formed by the third electrode plate and the fourth electrode plate. This configuration enables separate design of distinct electrode plate structures for corresponding detection when the prism carrier is rotatable in multiple directions.

In some embodiments, a number of third electrode plates is even, and the third electrode plates are symmetrically arranged about a first plane where the second rotation axis of the prism carrier is located, the first plane being perpendicular to a plane where the third electrode plates are located; a number of fourth electrode plates is even, and the fourth electrode plates are symmetrically arranged about the first plane; and the third electrode plates are in one-to-one correspondence with the fourth electrode plates, and each respective third electrode plate of the third electrode plates and a respective fourth electrode plate of the fourth electrode plates forms a capacitor.

In some embodiments, a plane where the first electrode plate is located and a plane where the second electrode plate is located are both parallel to the first rotation axis; and a plane where the third electrode plate is located and a plane where the fourth electrode plate is located are both parallel to the second rotation axis.

In some embodiments, a part of an orthographic projection of the first electrode plate toward the second electrode plate falls beyond the second electrode plate, and a part of an orthographic projection of the second electrode plate toward the first electrode plate falls beyond the first electrode plate.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic perspective structure view of a prism motor according to an embodiment of the present disclosure.

FIG. 2 is a schematic cross-sectional structure view of the prism motor according to an embodiment of the present disclosure.

FIG. 3 is a schematic structure view of the prism motor when a second electrode plate rotates about a first rotation axis X according to an embodiment of the present disclosure.

FIG. 4 is a schematic structure view of an arrangement of a first electrode plate and a second electrode plate in the prism motor according to an embodiment of the present disclosure.

FIG. 5 is a schematic structure view of another arrangement of the first electrode plate and the second electrode plate in the prism motor according to an embodiment of the present disclosure.

FIG. 6 is a schematic diagram illustrating spatial position changes of the second electrode plate rotating about the first rotation axis X in the prism motor according to an embodiment of the present disclosure.

FIG. 7 is a schematic diagram of simulation results of the prism motor according to an embodiment of the present disclosure.

FIG. 8 is a schematic diagram showing a comparison of sizes of the first electrode plate and the second electrode plate in the prism motor according to an embodiment of the present disclosure.

FIG. 9 is a schematic structure view of the prism motor when the second electrode plate rotates about a second rotation axis Y according to an embodiment of the present disclosure.

FIG. 10 is a top view structure view of an arrangement of a third electrode plate and a fourth electrode plate in the prism motor according to an embodiment of the present disclosure.

FIG. 11 is a top view structure view of another arrangement of the third electrode plate and the fourth electrode plate in the prism motor according to an embodiment of the present disclosure.

FIG. 12 is a top view structure view of yet another arrangement of the third electrode plate and the fourth electrode plate in the prism motor according to an embodiment of the present disclosure.

FIG. 13 is a schematic diagram illustrating a positional relationship between the first electrode plate and the second electrode plate in the prism motor according to an embodiment of the present disclosure.

FIG. 14 is a schematic diagram of a shape of the first electrode plate and the second electrode plate in the prism motor according to an embodiment of the present disclosure.

FIG. 15 is a schematic diagram of another shape of the first electrode plate and the second electrode plate in the prism motor according to an embodiment of the present disclosure.

FIG. 16 is a schematic diagram of yet another shape of the first electrode plate and the second electrode plate in the prism motor according to an embodiment of the present disclosure.

FIG. 17 is a flowchart of a method for detecting a rotation angle of the prism motor according to an embodiment of the present disclosure.

FIG. 18 is a schematic structure view of a photographing module according to an embodiment of the present disclosure.

### DETAILED DESCRIPTION OF THE EMBODIMENTS

To make the objects, technical solutions and advantages of the present disclosure clearer, embodiments of the present disclosure are described in detail below in conjunction with the accompanying drawings. Those of ordinary skill in the art should appreciate that in embodiments of the present disclosure, numerous technical details have been presented to enable better understanding of the present disclosure. However, even without these technical details and various variations and modifications based on the following embodiments, the technical solutions claimed in the present disclosure can be realized.

The division of various embodiments below is for descriptive convenience and shall not constitute any limitation on specific implementation manners of the present disclosure. The embodiments may be combined and cross-referenced with each other without contradiction.

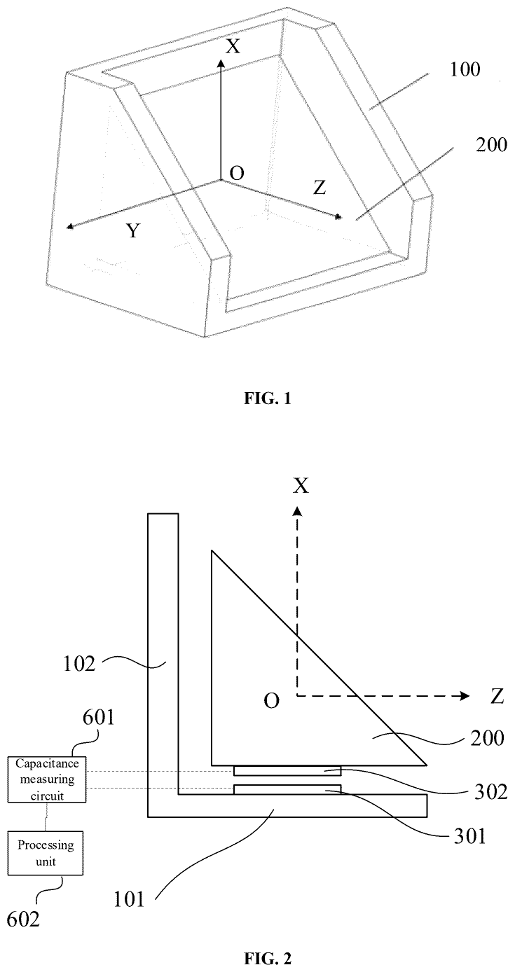

Embodiments of the present disclosure relate to a prism motor. As shown in FIGS. 1 to 2, the prism motor includes a prism base 100, a prism carrier 200, a first electrode plate 301, a second electrode plate 302, and a processing unit 602. The prism carrier 200 is spaced apart from the prism base 100 and rotatable relative to the prism base 100. The first electrode plate 301 is located on a surface of the prism base 100, and the second electrode plate 302 is located on a surface of the prism carrier 200 and disposed opposite to the first electrode plate 301. The first electrode plate 301 and the second electrode plate 302 form a capacitor, and in a case where the prism carrier 200 rotates in one direction about a first rotation axis, either an opposing area between the first electrode plate 301 and the second electrode plate 302 increases while a spacing between the first electrode plate 301 and the second electrode plate 302 decreases, or an opposing area between the first electrode plate 301 and the second electrode plate 302 decreases while a spacing between the first electrode plate 301 and the second electrode plate 302 increases. The processing unit 602 is configured to determine a rotation angle of the prism carrier 200 based on a capacitance signal generated by the capacitor formed by the first electrode plate 301 and the second electrode plate 302. In some embodiments, the prism motor includes further includes a capacitance measuring circuit 601 disposed between the capacitor and the processing unit 602 and configured to measure the capacitance signal generated by the capacitor and transmit the capacitance signal to the processing unit 602. When the prism carrier 200 rotates, the spacing between the first electrode plate 301 and the second electrode plate 302 refers to an average spacing between the first electrode plate 301 and the second electrode plate 302, which will be described later.

Compared with the related art, in the embodiments of the present disclosure, the first electrode plate 301 is disposed on the prism base 100, the second electrode plate 302 is disposed on the prism carrier 200, the capacitor formed by the first electrode plate 301 and the second electrode plate 302 is utilized to determine a rotation angle of the prism carrier 200 based on a change in capacitance signal, thereby enabling compensation for an angle change caused by shaking. Replacing a Hall sensor with electrode plates occupying smaller volume in the motor saves internal space occupied for implementing shake prevention technology in the prism motor, which is beneficial for miniaturization of the motor. Additionally, in the case where the prism carrier 200 rotates in one direction, both an opposing area and a spacing between the first electrode plate 301 and the second electrode plate 302 change simultaneously, and changes in the opposing area and the spacing have the same effect on capacitance signals, namely, changes in the opposing area and the spacing both cause an increase in capacitance signal or both cause a decrease in capacitance signal. Therefore, simultaneous changes in the opposing area and the spacing render a larger variation amplitude of the capacitance signal under the same rotation angle condition, which makes detection of the angular rotation of the prism carrier 200 more sensitive and improves effectiveness of detecting an offset angle of the prism carrier 200.

Additionally, as shown in FIG. 2, the prism base 100 includes a base bottom portion 101 and a base side portion 102 disposed on the base bottom portion 101. The first electrode plate 301 may be disposed on the base bottom portion 101 and/or the base side portion 102 according to a rotation direction of the prism carrier 200. The base side portion 102 includes a first base side portion, a second base side portion, and a third base side portion. The first base side portion is disposed opposite to the third base side portion, and the second base side portion connects the first base side portion to the third base side portion. That is, the prism base 100 is a semi-enclosed structure with three side walls and one bottom wall. In a case where the first electrode plate 301 is disposed on the base bottom portion 101, the second electrode plate 302 is oppositely disposed at a bottom of the prism carrier 200. In a case where the first electrode plate 301 is disposed on a rear side portion (i.e., the second base side portion) of the base side portion 102, the second electrode plate 302 is oppositely disposed on a side surface of the prism carrier 200 facing the rear side portion.

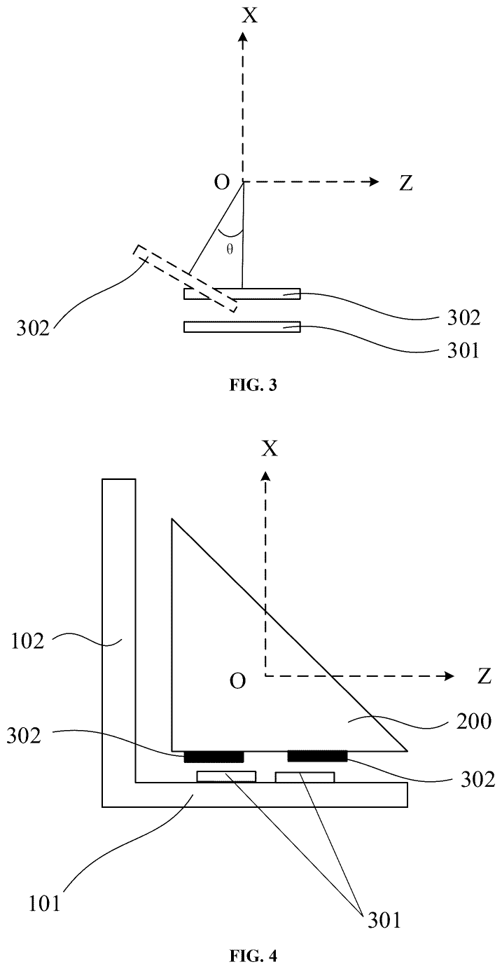

As shown in FIGS. 1 and 3, an X-axis direction is a direction of incident light entering the prism motor, a Z-axis direction is a direction of reflected light vertically entering a lens after reflection, and a Y-axis is perpendicular to an XZ plane. Taking rotation of the prism carrier 200 about a first rotation axis (i.e., the Y-axis) as an example, the first electrode plate 301 is fixed on the prism base 100, and before rotation of the prism carrier 200, a position of the second electrode plate 302 is shown by a solid line in FIG. 3. When the prism carrier 200 rotates about the first rotation axis (i.e., the Y-axis) by an angle θ, a position of the second electrode plate 302 is shown by a dashed line in FIG. 3. After rotation, an opposing area between the first electrode plate 301 and the second electrode plate 302 decreases, and an average spacing between the first electrode plate 301 and the second electrode plate 302 increases, causing a capacitance signal corresponding to the capacitor formed by the first electrode plate 301 and the second electrode plate 302 to change. The rotation angle θ of the second electrode plate 302 can be determined based on the change in the capacitance signal. Since the second electrode plate 302 is fixed to the prism carrier 200, namely, the rotation angle of the second electrode plate 302 corresponds to a rotation angle of the prism carrier 200, the rotation angle of the prism carrier 200 can be obtained according to the rotation angle of the second electrode plate 302, thus enabling compensation for the change in angle of the prism carrier 200 caused by shaking.

In some embodiments, when numbers of both the first electrode plates 301 and the second electrode plates 302 are even, the first electrode plates 301 are symmetrically arranged about a plane where the first rotation axis is located, and the second electrode plates 302 are also symmetrically arranged about the plane, the plane being perpendicular to a plane where the first electrode plates 301 are located.

As shown in FIG. 4, in the case where the prism carrier 200 rotates about the first rotation axis (Y-axis) and the first electrode plates 301 are disposed on the base bottom portion 101, the second electrode plates 302 are disposed at a bottom of the prism carrier 200 and are opposite to the first electrode plates 301. FIG. 4 exemplarily shows two first electrode plates 301 and two second electrode plates 302, where the two first electrode plates 301 are symmetrically arranged about a first plane where the first rotation axis is located, and the two second electrode plates 302 are also symmetrically arranged about the first plane, where the first plane is perpendicular to a plane where the two first electrode plates 301 are located. Here, the first plane is an XY-plane where the X-axis and the Y-axis are located. The plane where the first electrode plates 301 are located and a plane where the second electrode plates 302 are located are both parallel to the first rotation axis (i.e., the Y-axis). The first electrode plates 301 are in one-to-one correspondence with the second electrode plates 302, and each pair of the first electrode plate 301 and the second electrode plate 302 forms a capacitor. The processing unit is configured to determine a rotation angle of the prism carrier 200 based on capacitance signals generated by the capacitors formed by the first electrode plates 301 and the second electrode plates 302.

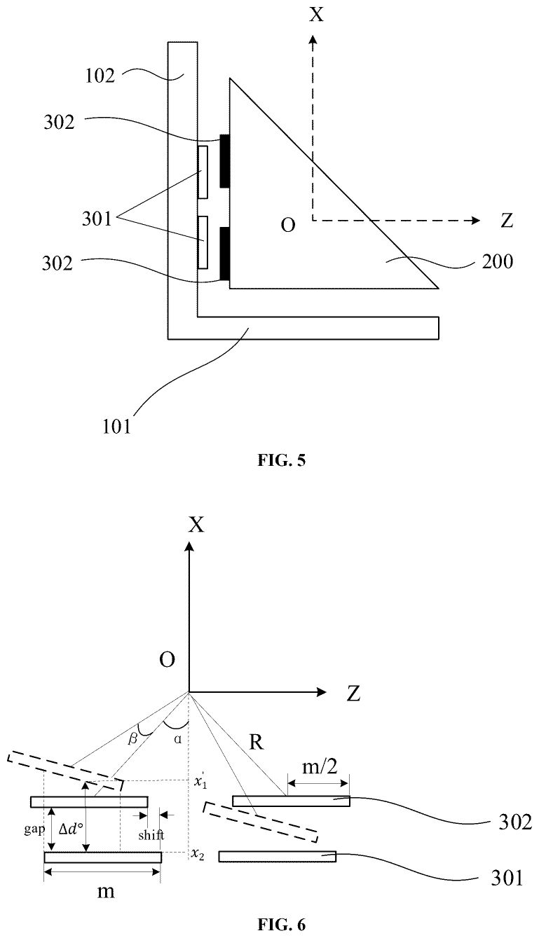

A shown in FIG. 5, in the case where the prism carrier 200 rotates about the first rotation axis (Y-axis) and the first electrode plates 301 are disposed on the second base side portion, the second electrode plates 302 is disposed a side surface of the prism carrier 200 facing the second base side portion and are opposite to the first electrode plates 301. FIG. 5 exemplarily shows two first electrode plates 301 and two second electrode plates 302, where the two first electrode plates 301 are symmetrically arranged about a second plane and the two second electrode plates 302 are also symmetrically arranged about the second plane, where the second plane is perpendicular to a plane where the two first electrode plates 301 are located. Here, the second plane is an XY-plane where the X axis and the Y axis are located. The plane where the first electrode plates 301 are located and the plane where the second electrode plates 302 are located are both parallel to the first rotation axis (i.e., the Y-axis). The first electrode plates 301 are in one-to-one correspondence with the second electrode plates 302, and each pair of the first electrode plate 301 and the second electrode plate 302 forms a capacitor. The processing unit is configured to determine a rotation angle of the prism carrier 200 based on capacitance signals generated by the capacitors formed by the first electrode plates 301 and the second electrode plates 302.

The following takes the first electrode plate and second electrode plate for the first rotation axis in FIG. 6 as an example to specifically explain a capacitance calculation method caused by rotation of the second electrode plate, using a left-side electrode plate capacitance calculation as an example.

When the second electrode plate 302 rotates clockwise about the Y-axis, an average spacing between the first electrode plate 301 and the second electrode plate 302 on the left side in the figure increases, while an opposing area S between the first electrode plate 301 and the second electrode plate 302 decreases. The increase in the average spacing and the decrease in the opposing area S jointly exacerbate a reduction in capacitance value. This approach thereby accelerates changes in capacitance and improves sensitivity of capacitance detection.

The following takes the first electrode plate and second electrode plate for the first rotation axis in FIG. 6 as an example to specifically explain a capacitance calculation method in rotation of the second electrode plate, using a left-side electrode plate capacitance calculation as an example.

When the second electrode plate 302 rotates clockwise about the Y-axis, an average spacing between the first electrode plate 301 and the second electrode plate 302 on the left side in the figure increases, while an opposing area S between the first electrode plate 301 and the second electrode plate 302 decreases. The increase in the average spacing and the decrease in the opposing area S jointly exacerbate a reduction in capacitance value, thereby accelerating the change in capacitance and improving sensitivity of capacitance detection.

An initial plane equation for the second electrode plate 302 on the left side in the figure is expressed as:

$${x}_{1} = - R cos α , {T}_{zm i n} = - R sin α - \frac{m}{2} , {T}_{zm ax} = - R sin α + \frac{m}{2} .$$

In the above equation, x₁ represents an X-axis coordinate value of an initial plane of the left-side second electrode plate 302, T_{zmin} represents a minimum Z-axis coordinate value of the initial plane of the left-side second electrode plate 302, T_{zmax} represents a maximum Z-axis coordinate value of the initial plane of the left-side second electrode plate 302, R represents a distance between a center of the initial plane of the second electrode plate and an origin O, α represents an angle between the X-axis and a line connecting the center of the initial plane of the second electrode plate to the origin O, and m represents a width of the second electrode plate.

An initial plane equation for the left-side first electrode plate 301 is expressed as:

$${x}_{2} = - R cos α , {R}_{zm i n} = - R sin α - \frac{m}{2} + shift , {R}_{z m ax} = - R sin α + \frac{m}{2} + shift .$$

In the above equation, x₂ represents an X-axis coordinate value of an initial plane of the left-side first electrode plate 301, R_{zmin} represents a minimum Z-axis coordinate value of the initial plane of the left-side first electrode plate 301, R_{zmax} represents a maximum Z-axis coordinate value of the initial plane of the left-side first electrode plate 301, m represents a width of the first electrode plate (here taking the first electrode plate and the second electrode plate having identical widths as an example, whereas in practical applications, the first electrode plate and the second electrode plate may be set to have different widths), and shift represents an offset amount between the first electrode plate and the second electrode plate in a width direction at an initial position.

When the prism carrier 200 rotates clockwise about the Y-axis by β degrees, a plane equation of the left-side second electrode plate 302 after rotation is expressed as:

$${z}_{1}^{′} = z cos β - x sin β = z cos β + R sin βcosα ;$$

$${x}_{1}^{′} = z cos β + x cos β = z sin β - R cos α cos β .$$

In the above equation,

$${z}_{1}^{′}$$

represents a Z-axis coordinate value of the second electrode plate 302 after rotation,

$${x}_{1}^{′}$$

represents an X-axis coordinate value of the second electrode plate 302 after rotation, z represents a Z-axis coordinate value of the second electrode plate 302 before rotation, x represents an X-axis coordinate value of the second electrode plate 302 before rotation, α represents an angle between the X-axis and the line connecting the center of the initial plane of the second electrode plate and the origin O, and β represents a rotation angle of the prism carrier 200.

Based on the above equations, an average spacing Δd between the first electrode plate 301 and the second electrode plate 302 on the left side in the figure after rotation can be calculated as follows:

$$Δ d = {x}_{1}^{′} - {x}_{2} .$$

After rotation, an overlapping coordinate range in the Z-axis direction between the first electrode plate 301 and the second electrode plate 302 on the left side in the figure is defined as:

$${z}_{ma x} = min ( {T}_{z m ax}^{′} , {R}_{zm ax} ) ;$$

$${z}_{m i n} = max ( {T}_{z m i n}^{′} , {R}_{z m i n} ) .$$

$${T}_{z m ax}^{′}$$

represents a maximum Z-axis coordinate value of an initial plane of the left-side second electrode plate 302 after rotation by β degrees, R_{zmax} represents a maximum Z-axis coordinate value of an initial plane of the left-side first electrode plate 301,

$${T}_{z m i n}^{′}$$

represents a minimum Z-axis coordinate value of the initial plane of the left-side second electrode plate 302 after rotation by β degrees, and R_{zmin} represents a minimum Z-axis coordinate value of the initial plane of the left-side first electrode plate 301.

Assuming a length of the electrode plate is L, a capacitance expression between the two electrode plates after rotation by β degrees can be expressed as follows:

$$C = {\int }_{{z}_{m i n}}^{{z}_{m ax}} \frac{{ϵ}_{r} \times L}{Δ d} d z .$$

∈ᵣ represents a dielectric coefficient of a dielectric between the first electrode plate and the second electrode plate.

For the calculation method of the above capacitance expression, simulation calculation is performed by determining corresponding capacitance signals for rotation about the Y-axis by β degrees, with initial parameters configured as shown in the following table.

| | |
|---|---|
| Initial distance between | Average spacing between the |
| the center of the second | first electrode plate and the |
| electrode plate and the origin O | second electrode plate |
| R = 4.5 mm | gap = 0.2 mm |
| Initial offset amount | Initial angle between |
| between the first | the X-axis and a line |
| electrode plate and the | connecting the center of the |
| second electrode plate | second electrode plate |
| shift = 0.2 mm | to the origin O |
| | α = 45 degrees |
| Widths of the first | Lengths of the first and |
| electrode plate and | second electrode plates |
| the second electrode plate | L = 3 mm |
| m = 3 mm | |

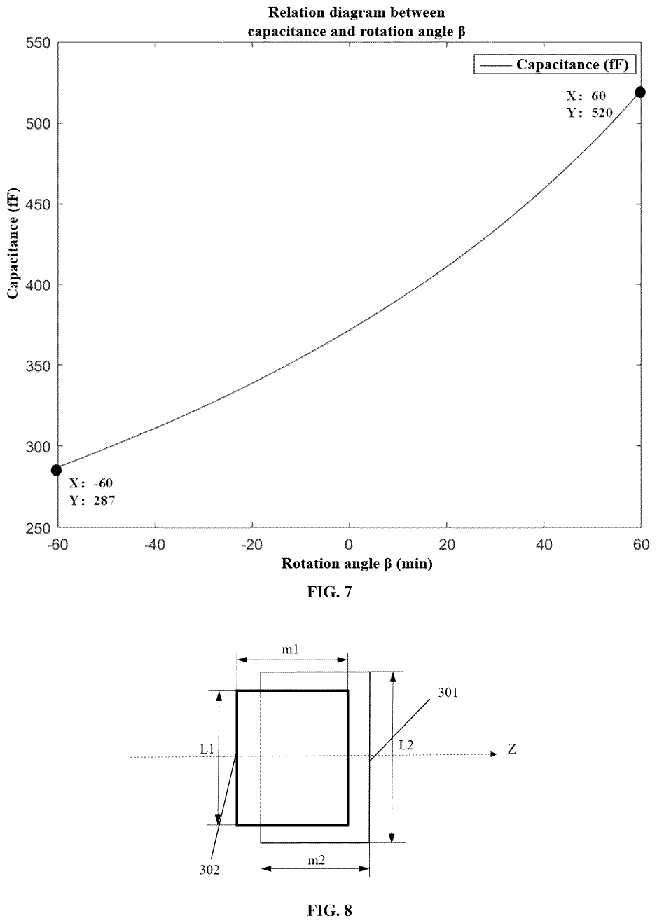

Using the initial parameters configured as above, simulation results of changes of capacitance values with the rotation angle β are obtained as shown in FIG. 7. Within a rotation angle β in a range of 1 degree (60 arc-minutes) under normal operating conditions of the prism motor, the capacitance exhibits favorable linearity and good capacitance detection sensitivity, facilitating determination of changes in rotation angle based on variations in capacitance signal. Additionally, if a length of an electrode plate is increased, an initial opposing area is enlarged, changes in capacitance signal become more pronounced, further enhancing capacitance detection sensitivity.

Additionally, each of the first electrode plates 301 is symmetrically arranged about a plane where the second rotation axis (X-axis) of the prism carrier 200 is located, and each of the second electrode plates 302 is symmetrically arranged about the plane where the second rotation axis of the prism carrier 200 is located, the plane being perpendicular to the plane where the first electrode plates are located. That is, each of the first electrode plate 301 and the second electrode plate 302 is symmetric about a ZX-plane where the X axis and the Z axis are located. The prism motor can rotate about the second rotation axis while rotating about the first rotation axis. By configuring the electrode plates as centrally symmetric structures that are symmetric relative to the above planes, changes in capacitance signals from multiple set of capacitors formed by the symmetric electrode plates remain substantially consistent during rotation of the prism motor about the rotation axis. This facilitates minimizing interference from rotation angles in another direction on detection results through subsequent calculations, thereby improving accuracy in calculating the rotation angle for rotation in a single direction.

After determining capacitance signals C1 and C2 generated by electrode plate pairs composed of two pairs of first electrode plates and second electrode plates in rotation about the first rotation axis (Y-axis), a final capacitance signal can be calculated by a formula C1-C2. Since rotation about the first rotation axis causes changes in capacitance signals C1 and C2 to be negatively correlated, namely, C1 decreases while C2 increases, or C1 increases while C2 decreases, calculating the final capacitance signal via the formula C1-C2 superimposes the two capacitance signals C1 and C2, thereby enhancing capacitance detection sensitivity. On the other hand, calculating the final capacitance via the formula C1-C2 can also partially cancel out changes in capacitance signals caused by rotation about the second rotation axis (i.e., the X-axis). Rotation about the second rotation axis causes changes in capacitance signals C1 and C2 to be positively correlated, namely, C1 decreases while C2 decreases, or C1 increases while C2 increases. Therefore, calculating the final capacitance via the formula C1-C2 can partially cancel out effects of rotation about the second rotation axis on capacitance signals C1 and C2.

Additionally, besides utilizing the above formula to superimpose multiple capacitance signals, comprehensive analysis can be performed using other formulas, such as employing (C1−C2)/(C1+C2) to perform differential processing on results of multiple capacitance signals. In practical applications, further processing may be applied to obtained capacitance signals according to capacitance detection conditions, such as performing correction or noise reduction processing on capacitance signals to eliminate noise caused by environmental factors or human operational factors that affects accuracy of calculation results.

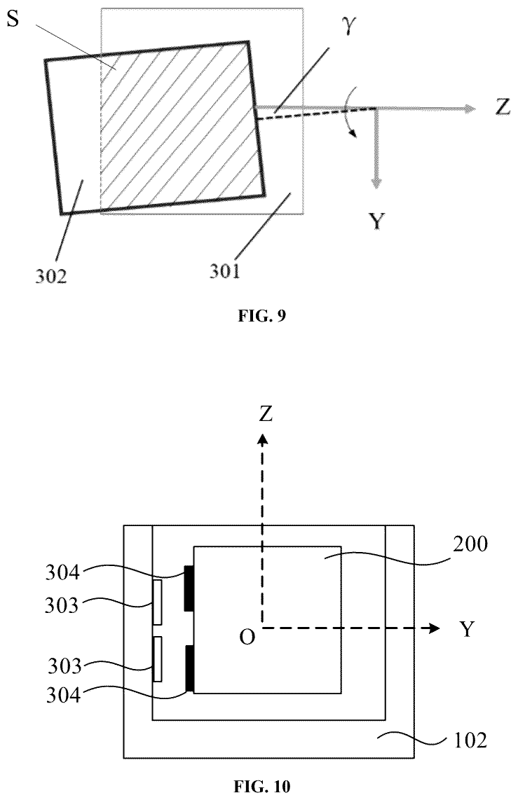

Additionally, when the prism carrier 200 rotates solely about the second rotation axis, an opposing area between the first electrode plate 301 and the second electrode plate 302 is maintained as constant as possible. This approach ensures that during rotation of the prism carrier 200 about the second rotation axis, the opposing area between the two electrode plates remains substantially unchanged with an average spacing unchanged. Consequently, influence of rotation about the second rotation axis on changes in capacitance signal between the first electrode plate 301 and the second electrode plate 302 can be reduced, and changes in capacitance signal between the first electrode plate 301 and the second electrode plate 302 more closely correspond to angle changes resulting from rotation about the first rotation axis. As shown in FIG. 8, areas of surfaces of the first electrode plate 301 and the second electrode plate 302 opposing to each other may be configured with different dimensions, where an area of the surface of the first electrode plate is set larger than an area of the surface of the second electrode plate, and a length of the first electrode plate is greater than a length of the second electrode plate, with a length direction parallel to the first rotation axis. This ensures that, as shown in FIG. 9, when the prism carrier rotates about the second rotation axis (i.e., the X-axis) within a rated rotation travel range of ±y, boundaries of the second electrode plate 302 in the width direction do not move beyond boundaries of the first electrode plate 301 in the width direction, and the opposing area 300 between the first electrode plate and the second electrode plate remains substantially unchanged. It is to be noted that the opposing area between the first electrode plate and the second electrode plate mentioned herein refers to an orthographic projection area of the first electrode plate on the second electrode plate.

Additionally, the prism motor further include a third electrode plate 303, a fourth electrode plate 304, and a processing unit. The third electrode plate 303 is located on a surface of the prism base 100, and the fourth electrode plate 304 is located on a surface of the prism carrier 200 and disposed opposite to the third electrode plate 303. The third electrode plate 303 and the fourth electrode plate 304 form a capacitor, and in a case where the prism carrier 200 rotates in one direction about the second rotation axis, either an opposing area between the third electrode plate and the fourth electrode plate increases while a spacing between the third electrode plate and the fourth electrode plate decreases, or an opposing area between the third electrode plate and the fourth electrode plate decreases while a spacing between the third electrode plate and the fourth electrode plate increases. The first rotation axis and the second rotation axis are mutually perpendicular. The processing unit is configured to collectively determine a spatial rotation angle of the prism carrier 200 based on the capacitance signal generated by the capacitor formed by the first electrode plate 301 and the second electrode plate 302 and a capacitance signal generated by the capacitor formed by the third electrode plate 303 and the fourth electrode plate 304. This configuration enables corresponding detection for multi-directional rotation of the prism carrier 200 through separately designed electrode plate structures

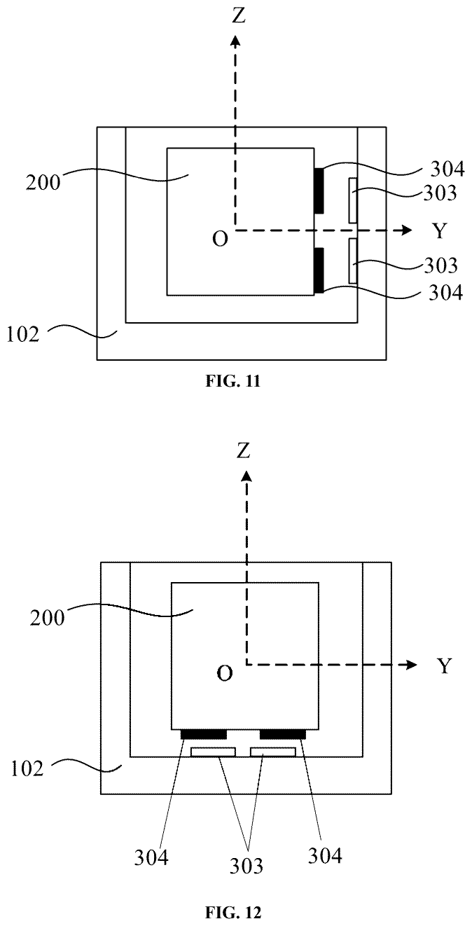

As shown in FIGS. 10 to 12, for the rotation axis being the X-axis, the third electrode plate 303 and the fourth electrode plate 304 may be arranged at different positions of the prism motor. As shown in FIG. 10, the third electrode plate 303 may be arranged on a left side portion (i.e., the first base side portion) of the base side portion 102 of the prism base 100 in the figure, and the fourth electrode plate 304 is correspondingly arranged at a left side surface of the prism carrier 200 in the figure. As shown in FIG. 11, the third electrode plate 303 may be arranged on a right side portion (i.e., the third base side portion) of the base side portion 102 of the prism base 100 in the figure, and the fourth electrode plate 304 is correspondingly arranged at a right side surface of the prism carrier 200 in the figure. As shown in FIG. 12, the third electrode plate 303 may be arranged on a rear side portion (i.e., the second base side portion) of the base side portion 102 of the prism base 100 in the figure, and the fourth electrode plate 304 is correspondingly arranged at a rear side surface of the prism carrier 200 in the figure.

Additionally, arrangement rules for the third electrode plate 303 and the fourth electrode plate 304 partially coincide with arrangement rules for the first electrode plate 301 and the second electrode plate 302. For example, when both the number of the third electrode plates and the number of the fourth electrode plates are even, the third electrode plates are symmetrically arranged about a plane where the rotation axis of the prism carrier 200 is located, and the fourth electrode plates are also symmetrically arranged about the plane where the rotation axis of the prism carrier 200 is located, the plane being perpendicular to a plane where the third electrode plates are located. The third electrode plates are in one-to-one correspondence with the fourth electrode plates, and each pair of the third electrode plate and the fourth electrode plate forms a capacitor. Arrangement of the third electrode plates and the fourth electrode plates aims to detect a rotation angle of the prism carrier 200 about the second rotation axis. A calculation method thereof refers to the above-described simulation results of capacitance signals generated by the first electrode plate 301 and the second electrode plate 302 versus rotation angles, which are not repeated herein.

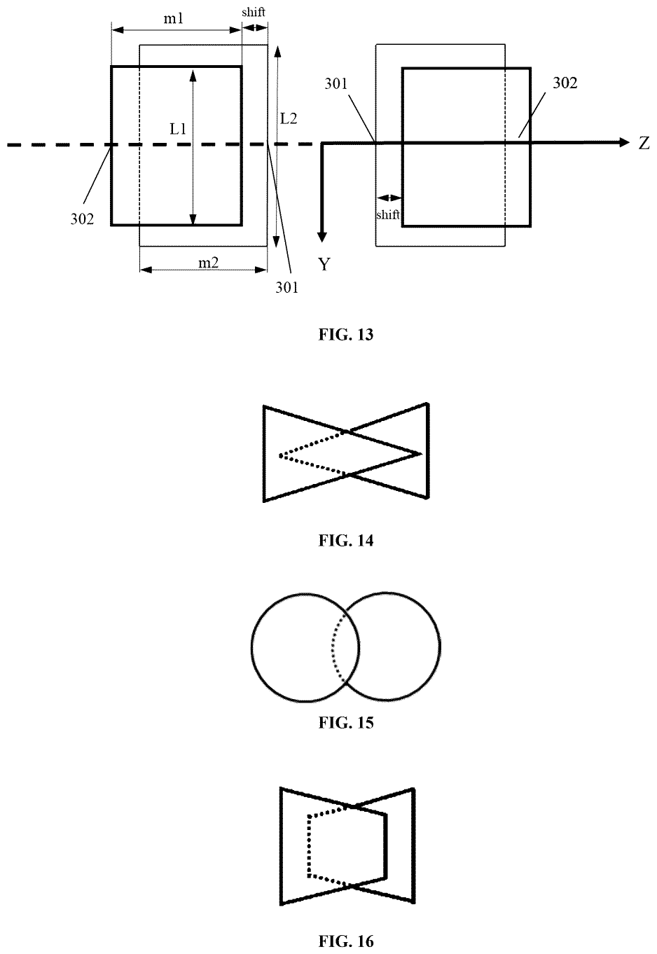

Additionally, as shown in FIG. 13, a part of an orthographic projection of the first electrode plate 301 toward the second electrode plate 302 falls beyond the second electrode plate 302, and a part of an orthographic projection of the second electrode plate 302 toward the first electrode plate 301 falls beyond the first electrode plate 301, with a shift existing between the orthographic projections of the two electrode plates. Similarly, a part of an orthographic projection of the third electrode plate toward the fourth electrode plate falls beyond the fourth electrode plate, and a part of an orthographic projection of the fourth electrode plate toward the third electrode plate falls beyond the third electrode plate, with a shift also possibly existing between the orthographic projections of the two electrode plates. To ensure that changes in opposing area and average spacing of each of two capacitors formed by two first electrode plates 301 and two second electrode plates 302 remain negatively correlated within a rated rotation range of the prism carrier 200, a numerical range of shift can be limited. Rules for limiting the numerical range of shift are as follows:

Taking the first electrode plate 301 and the second electrode plate 302 rotating about the first rotation axis (i.e., the Y-axis) in FIG. 6 as an example, according to the initial plane equation calculation method described above, a minimum initial Z-coordinate of the left-side second electrode plate 302 in FIG. 6 is R_{zmin}, and a maximum initial Z-coordinate is R_{zmax}. A plane rotation formula is expressed as:

$${z}_{1}^{′} = z cos β - x sin β = z cos β + R sin βcosα .$$

Using the plane rotation formula, a rotated minimum Z-coordinate

$${R}_{z m i n}^{′}$$

and a rotated maximum Z-coordinate

$${R}_{z m ax}^{′}$$

are respectively obtained. The numerical range of the shift is determined by formulas:

$$shift > \vert {R}_{zm ax}^{′} \sim {R}_{z ma x} \vert , and shift > \vert {R}_{zm i n}^{′} \sim {R}_{zm i n} \vert .$$

Additionally, considering compactness of internal structure of the prism motor, shapes of the first electrode plate 301 and the second electrode plate 302, as well as shapes of the third electrode plate 303 and the fourth electrode plate 304, may be shapes other than rectangular. Depending on space occupation conditions within the prism motor, the electrode plates may be configured as triangular electrode plates as shown in FIG. 14, or circular electrode plates as shown in FIG. 15, or other polygonal electrode plates such as trapezoidal electrode plates as shown in FIG. 16, or curvilinear electrode plates, combined in a paired manner.

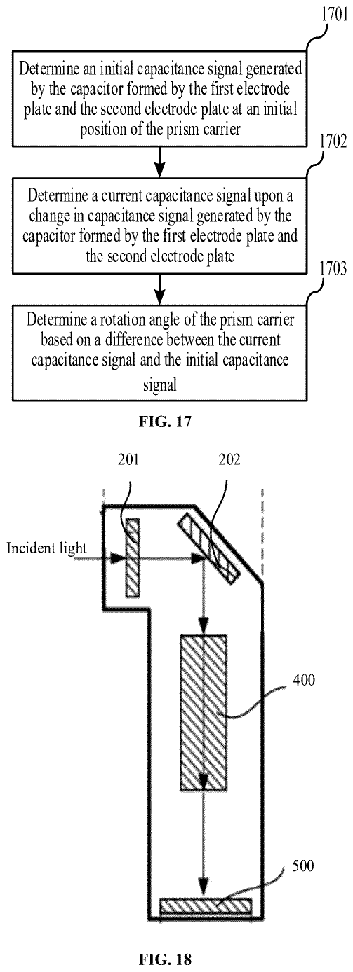

Embodiments of the present disclosure further relate to a method for detecting a rotation angle of a prism motor, applied to the aforementioned prism motor. As shown in FIG. 17, the method includes operations described below.

Operation 1701: determining an initial capacitance signal generated by a capacitor formed by the first electrode plate and the second electrode plate at an initial position of the prism carrier;

Operation 1702: determining a current capacitance signal upon a change in capacitance signal generated by the capacitor formed by the first electrode plate and the second electrode plate;

Operation 1703: determining a rotation angle of the prism carrier based on a difference between the current capacitance signal and the initial capacitance signal.

Embodiments of the present disclosure, compared with the related art, utilize electrode plates occupying smaller volume to replace Hall sensors in the prism motor, and calculate a rotation angle of the prism motor based on changes in capacitance signal of the capacitor formed between electrode plates, thereby saving internal volume occupied within the prism motor and facilitating miniaturization of the prism motor. After determining the rotation angle of the prism carrier, an anti-shaking effect can be achieved using the above-described rotation angle detection method by controlling the prism carrier to rotate to a target angle. For example, the target angle is an angle required for shake compensation, and rotation of the prism carrier is controlled according to a difference between a current rotation angle and the target angle. Since shaking occurs in real time during shooting, shake compensation control is also performed in real time, that is, one compensation cycle is followed by proceeding to judgment of a next compensation angle and a rotation control process of the prism carrier.

A calculation method for a correspondence relationship between capacitance signals generated by the capacitor formed by the first electrode plate and the second electrode plate and rotation angles is specifically described in the preceding embodiments. Specifically, rotation angles corresponding to different capacitance signals are determined based on the simulation curve generated through simulation of capacitance signals versus rotation angles.

Operation divisions in the various methods above are merely for descriptive clarity. During implementation, operations may be merged into a single operation, or a certain operation may be split into multiple operations. Any implementation involving a substantially identical logical relationship falls within the protection scope of the present disclosure. Insignificant modifications added to algorithms or processes, or introduction of trivial designs that do not alter the essential design concept of the algorithms and processes, also fall within the protection scope of the present disclosure.

Another feasible embodiment of the present disclosure relates to a photographing module. As shown in FIG. 18, the photographing module includes the aforementioned prism motor, a lens 400, and a photosensitive chip 500. Incident light entering the photographing module is reflected by the prism motor, passes through the lens 400, and reaches the photosensitive chip 500. Specifically, the incident light passes through a light-transmitting plate 201 into the photographing module, and a propagation direction of the incident light is altered by a reflector 202 of the prism motor, enabling the incident light to vertically penetrate the lens 400 and reach the photosensitive chip 500.

Compared with the related art, the photographing module provided in the embodiments of the present disclosure incorporates the prism motor described in the foregoing embodiments, and thus possesses the aforementioned technical effects, which are not repeated herein.

A person of ordinary skill in the art shall understand that the above embodiments are merely specific and exemplary embodiments for practicing the present disclosure, and in practice, various modifications may be made to these embodiments in terms of formality and detail, without departing from the spirit and scope of the present disclosure.

What is claimed is:

1. A prism motor, comprising:
a prism base;
a prism carrier, spaced apart from the prism base, wherein the prism carrier is rotatable relative to the prism base;
a first electrode plate, located on a surface of the prism base;
a second electrode plate, located on a surface of the prism carrier and disposed opposite to the first electrode plate, wherein the first electrode plate and the second electrode plate form a capacitor, and in a case where the prism carrier rotates in one direction about a first rotation axis, an opposing area between the first electrode plate and the second electrode plate increases while a spacing between the first electrode plate and the second electrode plate decreases, or an opposing area between the first electrode plate and the second electrode plate decreases while a spacing between the first electrode plate and the second electrode plate increases; and
a processing unit, configured to determine a rotation angle of the prism carrier based on a capacitance signal generated by the capacitor formed by the first electrode plate and the second electrode plate.

2. The prism motor according to claim 1, wherein:
a number of first electrode plates is even, and the first electrode plates are symmetrically arranged about a first plane where a first rotation axis of the prism carrier is located, the first plane being perpendicular to a plane where the first electrode plates are located;
a number of second electrode plates is even, and the second electrode plates are symmetrically arranged about the first plane;
the first electrode plates are in one-to-one correspondence with the second electrode plates, and each respective first electrode plate of the first electrode plates and a respective second electrode plate of the second electrode plates forms a capacitor; and
the processing unit is configured to determine the rotation angle of the prism carrier based on a capacitance signal generated by the capacitor formed by the respective first electrode plate and the respective second electrode plate.

3. The prism motor according to claim 2, wherein each of the first electrode plates is symmetrically arranged about a second plane where a second rotation axis of the prism carrier is located, and each of the second electrode plates is symmetrically arranged about the second plane, the second plane being perpendicular to the plane where the first electrode plates are located, wherein the first rotation axis and the second rotation axis are mutually perpendicular.

4. The prism motor according to claim 1, wherein the first electrode plate has a length greater than a length of the second electrode plate, and wherein a length direction of the first electrode plate is parallel to the first rotation axis.

5. The prism motor according to claim 1, further comprising:
a third electrode plate, located on the surface of the prism base; and
a fourth electrode plate, located on the surface of the prism carrier and disposed opposite to the third electrode plate, wherein the third electrode plate and the fourth electrode plate form a capacitor, and in a case where the prism carrier rotates in one direction about a second rotation axis, either an opposing area between the third electrode plate and the fourth electrode plate increases while a spacing the third electrode plate and the fourth electrode plate decreases, or an opposing area the third electrode plate and the fourth electrode plate decreases while a spacing the third electrode plate and the fourth electrode plate increases, wherein the first rotation axis and the second rotation axis are mutually perpendicular;
wherein the processing unit is configured to collectively determine a spatial rotation angle of the prism carrier based on the capacitance signal generated by the capacitor formed by the first electrode plate and the second electrode plate and a capacitance signal generated by the capacitor formed by the third electrode plate and the fourth electrode plate.

6. The prism motor according to claim 5, wherein:
a number of third electrode plates is even, and the third electrode plates are symmetrically arranged about a first plane where the second rotation axis of the prism carrier is located, the first plane being perpendicular to a plane where the third electrode plates are located;
a number of fourth electrode plates is even, and the fourth electrode plates are symmetrically arranged about the first plane;
the third electrode plates are in one-to-one correspondence with the fourth electrode plates, and each respective third electrode plate of the third electrode plates and a respective fourth electrode plate of the fourth electrode plates forms a capacitor.

7. The prism motor according to claim 2, further comprising:
a third electrode plate, located on the surface of the prism base; and
a fourth electrode plate, located on the surface of the prism carrier and disposed opposite to the third electrode plate, wherein the third electrode plate and the fourth electrode plate form a capacitor, and in a case where the prism carrier rotates in one direction about a second rotation axis, either an opposing area between the third electrode plate and the fourth electrode plate increases while a spacing the third electrode plate and the fourth electrode plate decreases, or an opposing area the third electrode plate and the fourth electrode plate decreases while a spacing the third electrode plate and the fourth electrode plate increases, wherein the first rotation axis and the second rotation axis are mutually perpendicular;
wherein the processing unit is configured to collectively determine a spatial rotation angle of the prism carrier based on the capacitance signal generated by the capacitor formed by the first electrode plate and the second electrode plate and a capacitance signal generated by the capacitor formed by the third electrode plate and the fourth electrode plate.

8. The prism motor according to claim 7, wherein:
a number of third electrode plates is even, and the third electrode plates are symmetrically arranged about a second plane where the second rotation axis of the prism carrier is located, the second plane being perpendicular to a plane where the third electrode plates are located;
a number of fourth electrode plates is even, and the fourth electrode plates are symmetrically arranged about the second plane;
the third electrode plates are in one-to-one correspondence with the fourth electrode plates, and each respective third electrode plate of the third electrode plates and a respective fourth electrode plate of the fourth electrode plates forms a capacitor.

9. The prism motor according to claim 1, wherein a plane where the first electrode plate is located and a plane where the second electrode plate is located are both parallel to the first rotation axis.

10. The prism motor according to claim 1, wherein:
a part of an orthographic projection of the first electrode plate toward the second electrode plate falls beyond the second electrode plate, and a part of an orthographic projection of the second electrode plate toward the first electrode plate falls beyond the first electrode plate.

11. A method for detecting a rotation angle of a prism motor, applied to a prism motor comprising:
a prism base;
a prism carrier, spaced apart from the prism base, wherein the prism carrier is rotatable relative to the prism base;
a first electrode plate, located on a surface of the prism base;
a second electrode plate, located on a surface of the prism carrier and disposed opposite to the first electrode plate, wherein the first electrode plate and the second electrode plate form a capacitor, and in a case where the prism carrier rotates in one direction about a first rotation axis, either an opposing area between the first electrode plate and the second electrode plate increases while a spacing between the first electrode plate and the second electrode plate decreases, or an opposing area between the first electrode plate and the second electrode plate decreases while a spacing between the first electrode plate and the second electrode plate increases; and
a processing unit, configured to determine a rotation angle of the prism carrier based on a capacitance signal generated by the capacitor formed by the first electrode plate and the second electrode plate;
the method comprising:
determining an initial capacitance signal generated by the capacitor formed by the first electrode plate and the second electrode plate at an initial position of the prism carrier;
determining a current capacitance signal upon a change in capacitance signal generated by the capacitor formed by the first electrode plate and the second electrode plate; and
determining a rotation angle of the prism carrier based on a difference between the current capacitance signal and the initial capacitance signal.

12. A photographing module, comprising:
a prism motor;
a lens; and
a photosensitive chip, wherein incident light entering the photographing module is reflected by the prism motor, passes through the lens, and reaches the photosensitive chip;
wherein the prism motor includes:
a prism base;
a prism carrier, spaced apart from the prism base, wherein the prism carrier is rotatable relative to the prism base;
a first electrode plate, located on a surface of the prism base;
a second electrode plate, located on a surface of the prism carrier and disposed opposite to the first electrode plate, wherein the first electrode plate and the second electrode plate form a capacitor, and in a case where the prism carrier rotates in one direction about a first rotation axis, either an opposing area between the first electrode plate and the second electrode plate increases while a spacing between the first electrode plate and the second electrode plate decreases, or an opposing area between the first electrode plate and the second electrode plate decreases while a spacing between the first electrode plate and the second electrode plate increases; and
a processing unit, configured to determine a rotation angle of the prism carrier based on a capacitance signal generated by the capacitor formed by the first electrode plate and the second electrode plate.

13. The photographing module according to claim 12, wherein:
a number of first electrode plates is even, and the first electrode plates are symmetrically arranged about a first plane where a first rotation axis of the prism carrier is located, the first plane being perpendicular to a plane where the first electrode plates are located;
a number of second electrode plates is even, and the second electrode plates are symmetrically arranged about the first plane;
the first electrode plates are in one-to-one correspondence with the second electrode plates, and each respective first electrode plate of the first electrode plates and a respective second electrode plate of the second electrode plates forms a capacitor; and
the processing unit is configured to determine the rotation angle of the prism carrier based on a capacitance signal generated by the capacitor formed by the respective first electrode plate and the respective second electrode plate.

14. The photographing module according to claim 13, wherein each of the first electrode plates is symmetrically arranged about a second plane where a second rotation axis of the prism carrier is located, and each of the second electrode plates is symmetrically arranged about the second plane the second plane being perpendicular to the plane where the first electrode plates are located, wherein the first rotation axis and the second rotation axis are mutually perpendicular.

15. The photographing module according to claim 12, wherein the first electrode plate has a length greater than a length of the second electrode plate, and wherein a length direction of the first electrode plate is parallel to the first rotation axis.

16. The photographing module according to claim 12, further comprising:
a third electrode plate, located on the surface of the prism base; and
a fourth electrode plate, located on the surface of the prism carrier and disposed opposite to the third electrode plate, wherein the third electrode plate and the fourth electrode plate form a capacitor, and in a case where the prism carrier rotates in one direction about a second rotation axis, either an opposing area between the third electrode plate and the fourth electrode plate increases while a spacing the third electrode plate and the fourth electrode plate decreases, or an opposing area the third electrode plate and the fourth electrode plate decreases while a spacing the third electrode plate and the fourth electrode plate increases, wherein the first rotation axis and the second rotation axis are mutually perpendicular;
wherein the processing unit is configured to collectively determine a spatial rotation angle of the prism carrier based on the capacitance signal generated by the capacitor formed by the first electrode plate and the second electrode plate and a capacitance signal generated by the capacitor formed by the third electrode plate and the fourth electrode plate.

17. The photographing module according to claim 16, wherein:
a number of third electrode plates is even, and the third electrode plates are symmetrically arranged about a first plane where the second rotation axis of the prism carrier is located, the first plane being perpendicular to a plane where the third electrode plates are located;
a number of fourth electrode plates is even, and the fourth electrode plates are symmetrically arranged about the first plane;
the third electrode plates are in one-to-one correspondence with the fourth electrode plates, and each respective third electrode plate of the third electrode plates and a respective fourth electrode plate of the fourth electrode plates forms a capacitor.

18. The photographing module according to claim 13, further comprising:
a third electrode plate, located on the surface of the prism base; and
a fourth electrode plate, located on the surface of the prism carrier and disposed opposite to the third electrode plate, wherein the third electrode plate and the fourth electrode plate form a capacitor, and in a case where the prism carrier rotates in one direction about a second rotation axis, either an opposing area between the third electrode plate and the fourth electrode plate increases while a spacing the third electrode plate and the fourth electrode plate decreases, or an opposing area the third electrode plate and the fourth electrode plate decreases while a spacing the third electrode plate and the fourth electrode plate increases, wherein the first rotation axis and the second rotation axis are mutually perpendicular;
wherein the processing unit is configured to collectively determine a spatial rotation angle of the prism carrier based on the capacitance signal generated by the capacitor formed by the first electrode plate and the second electrode plate and a capacitance signal generated by the capacitor formed by the third electrode plate and the fourth electrode plate.

19. The photographing module according to claim 12, wherein a plane where the first electrode plate is located and a plane where the second electrode plate is located are both parallel to the first rotation axis.

20. The photographing module according to claim 12, wherein:
a part of an orthographic projection of the first electrode plate toward the second electrode plate falls beyond the second electrode plate, and a part of an orthographic projection of the second electrode plate toward the first electrode plate falls beyond the first electrode plate.
